(19) United States
(12) Patent Application Publication
(10) Pub. No.: US 2012/0320189 A1
(43) Pub. Date: Dec. 20, 2012

(54) THERMAL IMAGER THAT ANALYZES TEMPERATURE MEASUREMENT CALCULATION ACCURACY

(75) Inventors: Michael D. Stuart, Issaquah, WA (US); James T. Pickett, Santa Cruz, CA (US)

(73) Assignee: FLUKE CORPORATION, Everett, WA (US)

(21) Appl. No.: 13/164,211

(22) Filed: Jun. 20, 2011

(51) Int. Cl. H04N 5/33; H04N 7/18

(52) U.S. Cl. 348/135; 348/E07.085; 348/E05.09

(57) ABSTRACT

A method and computer program product for determining whether an object of interest can have its temperature measurement calculated by a thermal imaging camera. To do this, the distance between the camera and the object of interest is measured, then a measurement IFOV is calculated using the measure distance. The measurement IFOV may be displayed on the screen of the camera as a graphical indicator of the object of interest can be registered with the graphical indicator and then it is determined whether the temperature measurement of the object can be acceptably calculated.

The present disclosure pertains to thermal imaging cameras that determine the accuracy of a calculated temperature measurement of an object of interest and, preferably, notify a user of the camera as to the accuracy of the calculated temperature measurement.

Handheld thermal imaging cameras, for example, including microbolometer detectors to generate infrared images, are used in a variety of applications, which include the inspection of buildings and industrial equipment. Many state-of-the-art thermal imaging cameras have a relatively large amount of built-in functionality allowing a user to select a display from among a host of display options, so that the user may maximize his ‘real time’, or on site, comprehension of the thermal information collected by the camera.

As is known, infrared cameras generally employ a lens assembly working with a corresponding infrared focal plane array (FPA) to provide an infrared or thermal image of a view in a particular axis. The operation of such cameras is generally as follows. Infrared energy is accepted via infrared optics, including the lens assembly, and directed onto the FPA of microbolometer infrared detector elements or pixels. Each pixel responds to the heat energy received by changing its resistance value. An infrared (or thermal) image can be formed by measuring the pixels' resistances—via applying a voltage to the pixels and measuring the resulting currents or applying current to the pixels and measuring the resulting voltages. A frame of image data may, for example, be generated by scanning all the rows and columns of the FPA. A dynamic thermal image (i.e., a video representation) can be generated by repeatedly scanning the FPA to form successive frames of data. Successive frames of thermal image data are generated by repeatedly scanning the rows of the FPA; such frames are produced at a rate sufficient to generate a video representation of the thermal image data.

Often, the user of the camera needs to know his distance from an object of interest. This is sometimes necessitated by safety concerns when a user is inspecting, for example, electrical or other potentially hazardous equipment and the user is required to be a certain distance from the equipment. Likewise, sometimes the distance from an object of interest to the user also can affect performance accuracy capabilities of a thermal imager being used for inspection work.

The following drawings are illustrative of particular embodiments of the invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

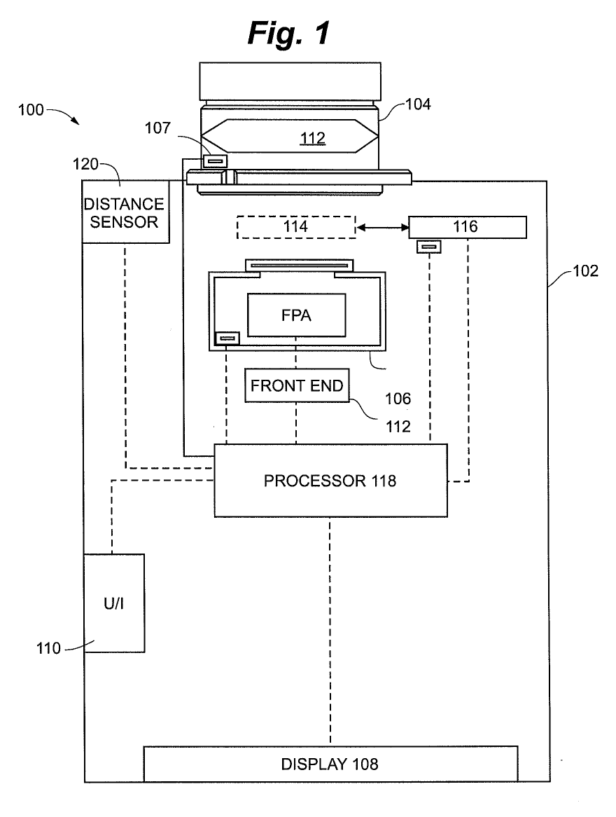

FIG. 1 is a schematic diagram of an infrared camera according to some embodiments of the present invention.

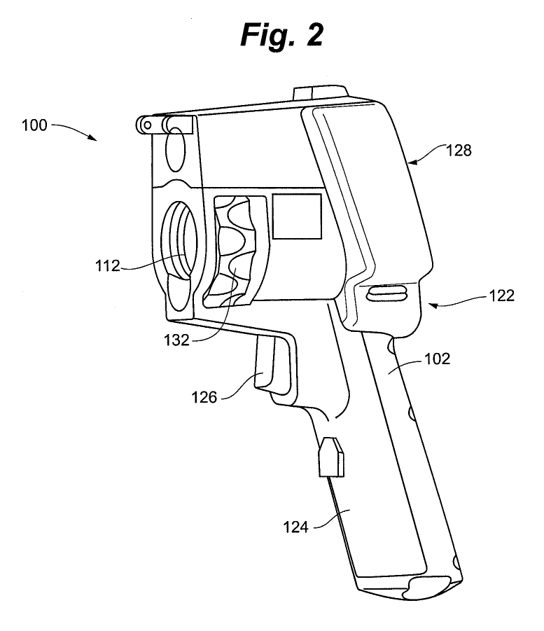

FIG. 2 is a front perspective view of an infrared camera according to some embodiments of the present invention.

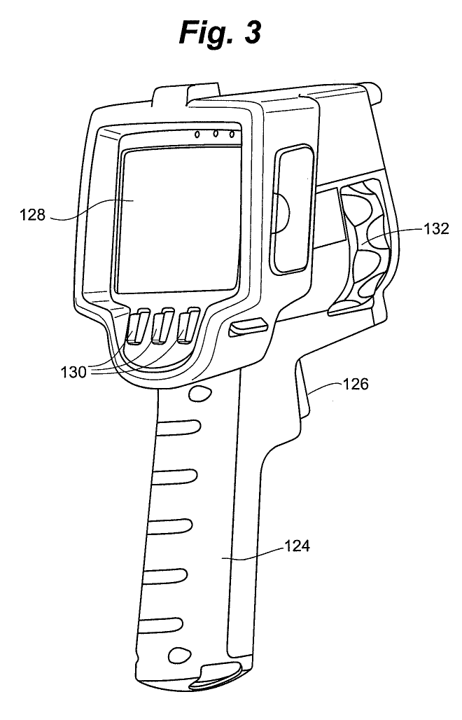

FIG. 3 is a back perspective view of an infrared camera according to some embodiments of the present invention.

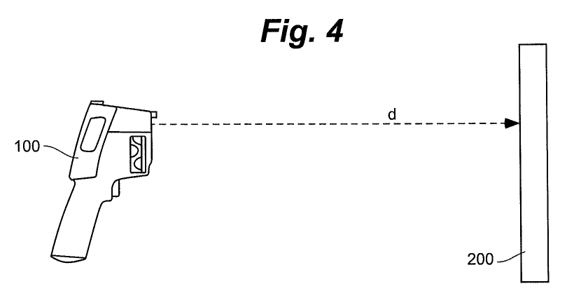

FIG. 4 is a schematic illustration of measuring the distance between the camera and an object of interest.

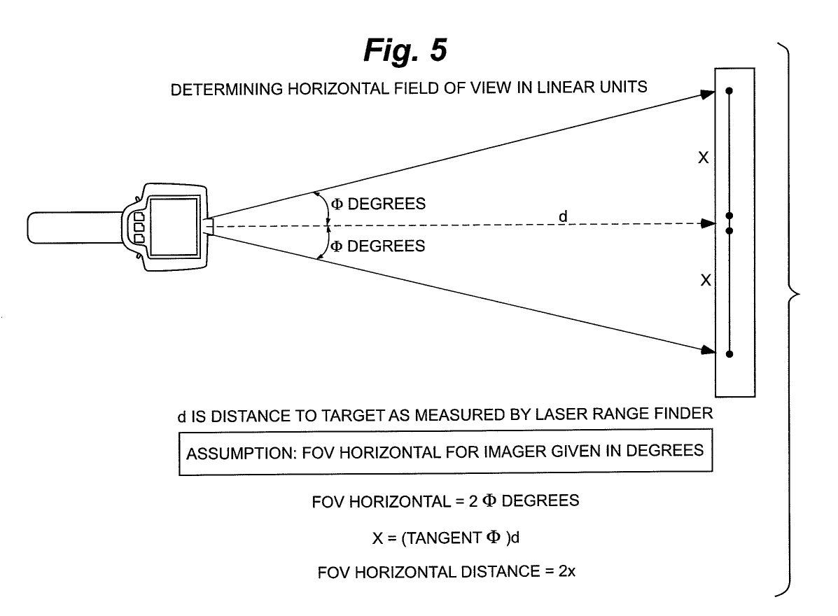

FIG. 5 is a schematic illustration of determining vertical field of view in linear units.

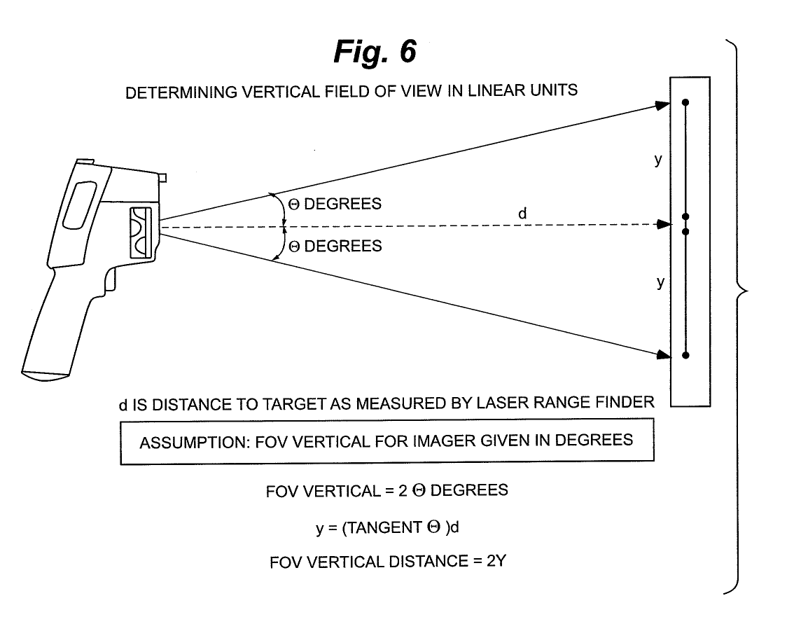

FIG. 6 is a schematic of illustration of determining horizontal field of view in linear units.

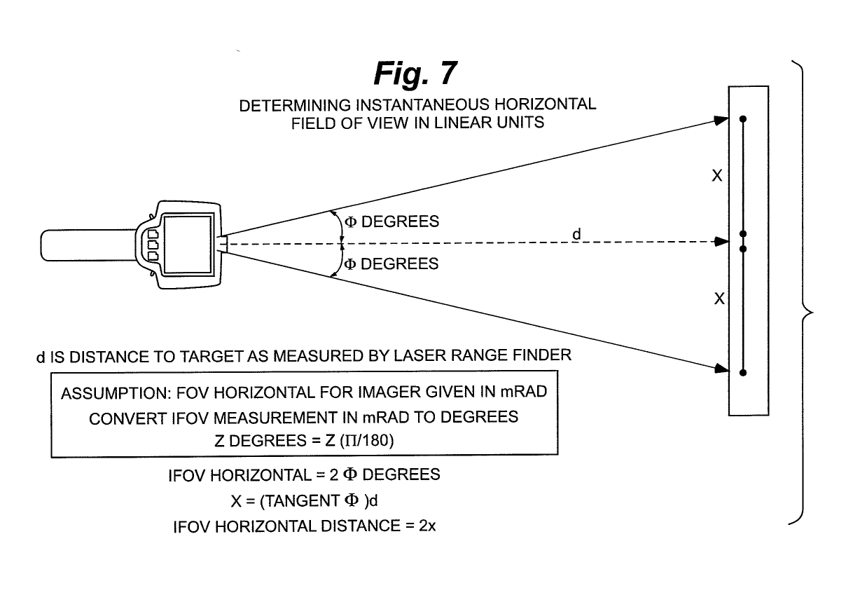

FIG. 7 is a schematic illustration of determining vertically spatial instantaneous field of view in linear units.

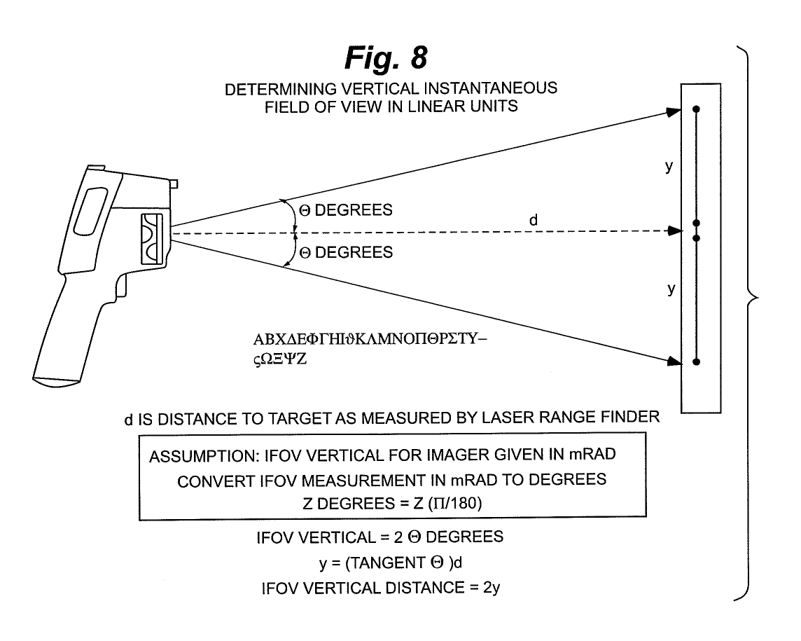

FIG. 8 is a schematic illustration of determining horizontal spatial instantaneous field of view in linear units.

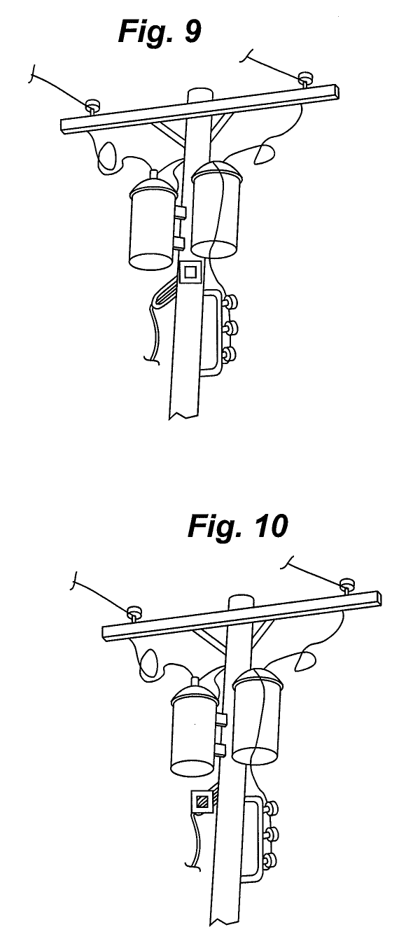

FIG. 9 is a screen shot of an infrared or thermal image showing a measurement target.

FIG. 10 is another screen shot of an infrared or thermal image showing a different measurement target.

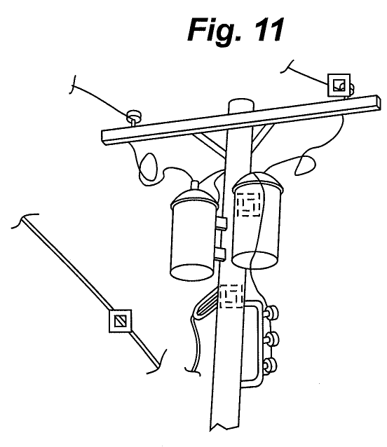

FIG. 11 is a marked-up screen shot of an infrared or thermal image showing multiple measurement targets.

FIG. 12 is an illustration of a 3×3 pixel matrix in a state where an accurate temperature measurement can be made.

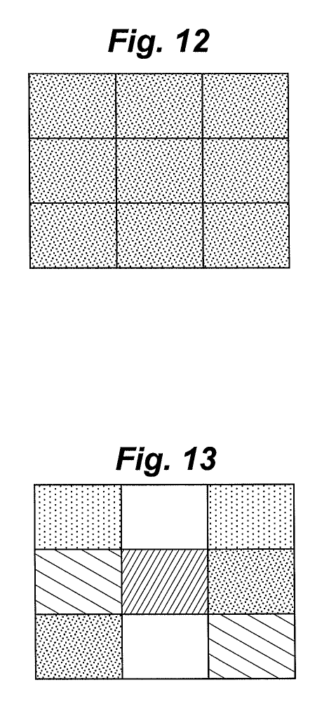

FIG. 13 is an illustration of the 3×3 pixel matrix in a state where an accurate temperature measurement cannot be made.

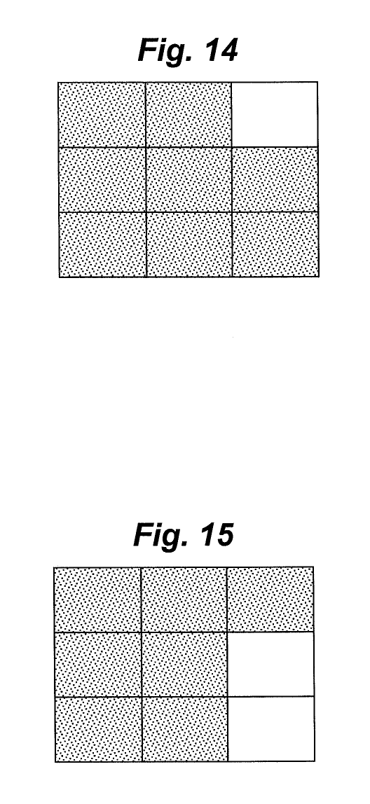

FIGS. 14 and 15 are illustrations of the 3×3 pixel matrix in a state where an accurate measurement can be made.

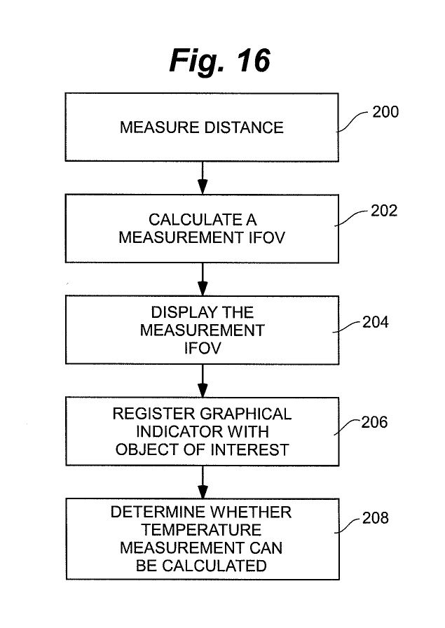

FIG. 16 is a flow chart of a method of determining whether an object of interest can have its temperature measurement calculated by a thermal imaging camera according to an embodiment of the invention.

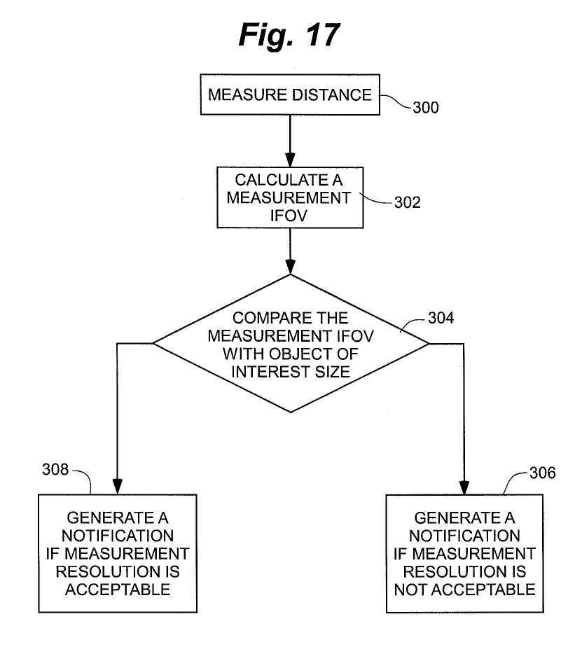

FIG. 17 is a flow chart of a method of determining whether an object of interest can have its temperature measurement calculated by a thermal imaging camera according to an embodiment of the invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the invention. Like numbers in multiple drawing figures denote like elements.

FIG. 1 provides a schematic diagram of an IR camera 100 according to certain embodiments of the present invention. Camera 100 includes camera housing 102 that holds several components including an IR lens assembly 104 and an infrared sensor 106, such as a focal plane array (FPA) of microbolometers. The housing 102 includes a display 108 and a user interface 110. The display 108 is used for displaying infrared or thermal image data and other information to the user. The user interface 110 contains various controls with which the user may control and operate the camera 100. The housing 102 also holds an electronic system that controls camera operation and communicates, as shown by the dotted lines, with several of the camera 100 components. The lens assembly 104 includes an IR lens 112 for receiving a cone of IR energy from a target scene.

In operation, the camera 100 receives image information in the form of infrared energy through the lens 112, and in turn, the lens 112 directs the infrared energy onto the FPA 106. The combined functioning of the lens 112 and FPA 106 enables further electronics within the camera 100 to create an image based on the image view captured by the lens 112, as described below.

The FPA 106 can include a plurality of infrared detector elements (not shown), e.g., including bolometers, photon detectors, or other suitable infrared detectors well known in the art, arranged in a grid pattern (e.g., an array of detector elements arranged in horizontal rows and vertical columns). The size of the array can be provided as desired and appropriate given the desire or need to limit the size of the distal housing to provide access to tight or enclosed areas. For example, many commercial thermal imagers have arrays of 640×480, 384×288, 320×240, 280×210, 240×180 and 160×120 detector elements, but the invention should not be limited to such. Also, some arrays may be 120×120, 80×80 or 60×60 detector elements, for example. In the future, other sensor arrays of higher pixel count will be more commonplace, such as 1280×720, for example. In fact, for certain applications, an array as small a single detector (i.e. a 1×1 array) may be appropriate. (It should be noted a camera 100 including a single detector, should be considered within the scope of the terms “thermal imaging camera” as they are used throughout this application, even though such a device may not be used to create an “image”). Alternatively, some embodiments can incorporate very large arrays of detectors. In some embodiments involving bolometers as the infrared detector elements, each detector element is adapted to absorb heat energy from the scene of interest (focused upon by the lens xx) in the form of infrared radiation, resulting in a corresponding change in its temperature, which results in a corresponding change in its resistance. With each detector element functioning as a pixel, a two-dimensional image or picture representation of the infrared radiation can be further generated by translating the changes in resistance of each detector element into a time-multiplexed electrical signal that can be processed for visualization on a display or storage in memory (e.g., of a computer). Further front end circuitry 112 downstream from the FPA 106, as is described below, is used to perform this translation. Incorporated on the FPA 106 is a Read Out Integrated Circuit (ROIC), which is used to output signals corresponding to each of the pixels. Such ROIC is commonly fabricated as an integrated circuit on a silicon substrate. The plurality of detector elements may be fabricated on top of the ROIC, wherein their combination provides for the FPA 106. In some embodiments, the ROIC can include components discussed elsewhere in this disclosure (e.g. an analog-to-digital converter (ADC)) incorporated directly onto the FPA circuitry. Such integration of the ROIC, or other further levels of integration not explicitly discussed, should be considered within the scope of this disclosure.

As described above, the FPA 106 generates a series of electrical signals corresponding to the infrared radiation received by each infrared detector element to represent a thermal image. A “frame” of thermal image data is generated when the voltage signal from each infrared detector element is obtained by scanning all of the rows that make up the FPA 106. Again, in certain embodiments involving bolometers as the infrared detector elements, such scanning is done by switching a corresponding detector element into the system circuit and applying a bias voltage across such switched-in element. Successive frames of thermal image data are generated by repeatedly scanning the rows of the FPA 106, with such frames being produced at a rate sufficient to generate a video representation (e.g. 30 Hz, or 60 Hz) of the thermal image data.

In some embodiments, the camera 100 can further include a shutter 114 mounted within the camera housing 102. A shutter 114 is typically located internally relative to the lens 112 and operates to open or close the view provided by the lens 112. In the shutter open position 116, the shutter 114 permits IR radiation collected by the lens to pass to the FPA 106. In the closed position 114, the shutter blocks IR radiation collected by the lens from passing to the FPA 106. As is known in the art, the shutter 114 can be mechanically positionable, or can be actuated by an electro-mechanical device such as a DC motor or solenoid. Embodiments of the invention may include a calibration or setup software implemented method or setting which utilize the shutter 114 to establish appropriate bias (e.g. see discussion below) levels for each detector element.

The camera may include other circuitry (front end circuitry) for interfacing with and controlling the optical components. In addition, front end circuitry 112 initially processes and transmits collected infrared image data to the processor 118. More specifically, the signals generated by the FPA 106 are initially conditioned by the front end circuitry 112 of the camera 100. In certain embodiments, as shown, the front end circuitry 112 includes a bias generator and a pre-amp/integrator. In addition to providing the detector bias, the bias generator can optionally add or subtract an average bias current from the total current generated for each switched-in detector element. The average bias current can be changed in order (i) to compensate for deviations to the entire array of resistances of the detector elements resulting from changes in ambient temperatures inside the camera 100 and (ii) to compensate for array-to-array variations in the average detector elements of the FPA 106. Such bias compensation can be automatically controlled by the camera 100 via processor 118. Following provision of the detector bias and optional subtraction or addition of the average bias current, the signals can be passed through a pre-amp/integrator. Typically, the pre-amp/integrator is used to condition incoming signals, e.g., prior to their digitization. As a result, the incoming signals can be adjusted to a form that enables more effective interpretation of the signals, and in turn, can lead to more effective resolution of the created image. Subsequently, the conditioned signals are sent downstream into the processor 118 of the camera 100.

In some embodiments, the front end circuitry can include one or more additional elements for example, additional sensors or an ADC. Additional sensors can include, for example, temperature sensors 107, visual light sensors (such as a CCD), pressure sensors, magnetic sensors, etc. Such sensors can provide additional calibration and detection information to enhance the functionality of the camera 100. For example, temperature sensors can provide an ambient temperature reading near the FPA 106 to assist in radiometry calculations. A magnetic sensor, such as a Hall effect sensor, can be used in combination with a magnet mounted on the lens to provide lens focus position information. Such information can be useful for calculating distances, or determining a parallax offset for use with visual light scene data gathered from a visual light sensor.

Generally, the processor 118, can include one or more of a field-programmable gate array (FPGA), a complex programmable logic device (CPLD) controller and a computer processing unit (CPU) or digital signal processor (DSP). These elements manipulate the conditioned scene image data delivered from the front end circuitry in order to provide output scene data that can be displayed or stored for use by the user. Subsequently, the processor 118 circuitry sends the processed data to the display 108, internal storage, or other output devices.

In addition to providing needed processing for infrared imagery, the processor circuitry can be employed for a wide variety of additional functions. For example, in some embodiments, the processor 118 can perform temperature calculation/conversion (radiometry), fuse scene information with data and/or imagery from other sensors, or compress and translate the image data. Additionally, in some embodiments, the processor 118 can interpret and execute commands from the user interface 110. This can involve processing of various input signals and transferring those signals where other camera components can be actuated to accomplish the desired control function. Exemplary control functions can include adjusting the focus, opening/closing the shutter, triggering sensor readings, adjusting bias values, etc. Moreover, input signals may be used to alter the processing of the image data that occurs at the processor 118.

The processor 118 circuitry can further include other components to assist with the processing and control of the camera 100. For example, as discussed above, in some embodiments, an ADC can be incorporated into the processor 118. In such a case, analog signals conditioned by the front-end circuitry 112 are not digitized until reaching the processor 118. Moreover, some embodiments can include additional on board memory for storage of processing command information and scene data, prior to transmission to the display 108.

The camera 100 may include a user interface 110 that has one or more controls for controlling device functionality. For example, the camera 100 may include a knob or buttons installed in the handle for adjusting the focus or triggering the shutter.

Camera 100 may also contain a visible light (VL) camera module. The placement of the VL camera optics and IR camera optics is such that the visible and infrared optical axes are offset and roughly parallel to each other, thereby resulting in parallax error.

The parallax error may be corrected manually or electronically. For example, U.S. Pat. No. 7,538,326 entitled “Visible Light and IR Combined Image Camera with a Laser Pointer,” is incorporated herein in its entirety, discloses a parallax error correction architecture and methodology. This provides the capability to electronically correct the IR and VL images for parallax. In some embodiments, thermal instrument 100 includes the ability to determine the distance to target and contains electronics that correct the parallax error caused by the parallel optical paths using the distance to target information.

For instance, camera 100 may include a distance sensor 120 that can be used to electronically measure the distance to target. Several different types of distances sensors may be used, such as laser diodes, infrared emitters and detectors, ultrasonic emitters and detectors, for example. The output of the distance sensor 120 may be fed to the processor 118 for use by the processor 118.

FIG. 2 shows a front perspective view of an infrared camera 100, according to some embodiments of the present invention. FIG. 3 shows a rear perspective view of the camera 100, according to some embodiments of the present invention. Camera 100 includes camera housing 102. An upper portion of housing 122 of camera 100 holds an engine assembly and the lower portion extends into a handle 124 for helping grasp camera 100 during use. The handle 124 includes a trigger 126 for image capture. A display 128 is located on the back of the instrument so that infrared images, visible light images, and/or blended images of infrared and visible light can be displayed to the user. Camera 100 includes a user interface 130 (see FIG. 3) that includes one or more buttons for controlling device functionality.

With reference to FIG. 2, the IR lens assembly may include a rotatable outer ring 132 having depressions to accommodate a tip of an index finger. Rotation of the outer ring 132 changes the focus of the IR lens 112.

Typical infrared lenses have a low F-number, resulting in a shallow depth of field. Accordingly, as noted above in the '326 patent incorporated by reference, the camera can sense the lens position in order to determine the distance to target.

A thermal imager is defined by many parameters among which are its Field Of View (FOV), its Instantaneous Field Of View (IFOV) and its measurement instantaneous Field of View (IFOV measurement). The imager's FOV is the largest area that the imager can see at a set distance. It is typically described in horizontal degrees by vertical degrees, for example, 23°×17°, where degrees are units of angular measurement. Essentially, the FOV is a rectangle extending out from the center of the imager's lens extending outward. By analogy, an imager's FOV can be thought of as a windshield that one is looking out as one drives one's car down the road. The FOV is from the top of the windshield to the bottom, and from the left to the right. An imager's IFOV, otherwise known as its spatial resolution, is the smallest detail within the FOV that can be detected or seen at a set distance. IFOV is typically measure in units called milliradians (mRad). IFOV represents the camera's spatial resolution only, not its temperature measurement resolution. Thus, the spatial IFOV of the camera may well find a small hot or cold spot but not necessarily be able to calculate its temperature measurement accurately because of the camera's temperature measurement resolution. Continuing the window shield analogy, the spatial IFOV can be thought of as the ability to see a roadside sign in the distance thought the windshield. One can see that it is a sign but one may not be able to read what is on the sign when the sign becomes first recognizable. To be able to calculate the temperature measurement of an object of interest relies on the imager's IFOVₘₑₐₛᵤᵣₑₘₑₙₜ, otherwise known as the camera's measurement resolution. It is the smallest detail that one can get an accurate calculated temperature measurement upon at a set distance. IFOVₘₑₐₛᵤᵣₑₘₑₙₜ is also specified in milliradians and is often two to three times the specified spatial resolution because it needs more imaging data is needed to accurately calculate a temperature measurement. Returning to the windshield/road analogy, when one sees the sign in the distance but one cannot read it, one would either move closer until one could read it or one would use an optical device to effectively bring one closer so that one could read the sign. The IFOVₘₑₐₛᵤᵣₑₘₑₙₜ is the size that the object of interest needs to be in order to read it. In order to know these parameters, one has to know the distance the camera is from an object of interest.

FIG. 4 illustrates using the IR camera 100 to measure a distance, d, between itself and an object of interest 200. Various distance measuring devices may be incorporated into the camera such as a laser distance measurement device, as previously mentioned.

FIGS. 5 and 6 are schematic illustrations of calculating the vertical and horizontal field of view (FOV) of the camera at a certain set distance, d, in linear units. As previously mentioned, normally for each camera its FOV_{horizontal} and FOV_{vertical} are given in degrees such as 23°×17°. The following calculations are used to convert the FOX into linear units:

FOV_{vertical}=2θ

Y=(Tangent θ)multiplied by d

So FOV_{vertical distance}=2y

Next, FIGS. 7 and 8 illustrate calculating the vertical and horizontal IFOV, respectively, of the camera at that distance, d, in linear units. This is the spatial resolution, the smallest detail within the FOV that can be seen or detected at the set distance. As previously mentioned, IFOV is usually specified in mRad so that needs to be converted to degrees and then the same equations used to determine FOV values may be used to determine IFOV values.

The IFOVₘₑₐₛᵤᵣₑₘₑₙₜ determines what can be accurately calculated, temperature wise at that distance, d. Thus, while an object of interest may be in the camera's IFOVₛₚₐₜᵢₐₗ one may not be able to accurately calculate its temperature because the object of interest is not within the camera's measurement resolution.

As previously mentioned, typically the temperature measurement resolution of the camera is two to three times larger than its spatial resolution. The IFOVₘₑₐₛᵤᵣₑₘₑₙₜ at the set distance, d, may be determined or calculated by either simply multiplying the IFOVₛₚₐₜᵢₐₗ by a factor of 2 or 3. Alternately, the IFOVₘₑₐₛᵤᵣₑₘₑₙₜ may be determined by processing the values obtained by the pixels as will be described hereinafter.

FIG. 9 shows a screen shot of a thermal or infrared image on the camera's display 108 (See FIG. 1) viewable by a user of the camera. The screen shows the camera's FOV at the current measured distance. Within the FOV are various items that can be seen, a transformer pole, two transformers, wiring and another pole, all of which are in the camera's IFOV spatial.

One can see from the displayed image that one of the transformers is emitting more radiant energy than the other as shown by its brightness.

Preferably, the IFOV measurement is calculated at this distance from the target and a graphical icon is placed on the LCD screen. In this embodiment, the graphical icon is a square which represents the size an object of interest needs to be in the image in order to have its temperature accurately calculated. Preferably the box is located in the center of the screen, however, it may be located at other positions. The graphical icon is registered on the first pole. It can be seen that the pole fills the area delineated by the graphical icon. In such a situation, the calculation of temperature from each pixel should be of a comparable temperature since they are all exposed to the same object of interest, the pole. As will be discussed hereinafter, the camera will indicate to the user that the calculated temperature measurement of the pole should be acceptable.

FIG. 10 illustrates a situation where the calculated temperature measurement will not be acceptable. The graphical icon is registered on a wire. While the wire meets the camera's spatial resolution, it does not meet the camera's temperature measurement resolution because the pixels are also receiving energy information from the surrounding environment, in this case the atmosphere. Thus, the calculated temperature will be a blend of the wire temperature and the atmosphere temperature and thus will not accurately represent the calculated temperature measurement of the wire.

FIG. 11 is a marked-up screen shot of an infrared or thermal image showing multiple measurement targets.

In the representative screen shot shown in FIG. 11, there are four boxes shown by way of example. For practical purposes, there will be one box located in the center of the image so FIG. 11 represents, with respect to the graphical icon, four different images.

Looking first at the transformer as the object of interest, when the graphical icon is registered with it, the transformer is large enough at that distance to have its temperature measurement accurately calculated. The same is true when the graphical icon is registered with the pole as previously discussed.

Contrarily, when the graphical icon is registered with the top wire, while one is able to see the wire using thermal imagery, it is not large enough at this particular distance, to have its temperature measurement accurately calculated. The user will have to either get physically closer to the wire or get optically closer by using a telephoto lens, for example, so that at a new distance enough of the wire fills the box representing the imagers' IFOVₘₑₐₛᵤᵣₑₘₑₙₜ in order to have its temperature accurately calculated. The same is true with splice on the lower wire. At this particular distance, the imager is also picking up the surrounding energy of the atmosphere and does not allow for an accurate temperature measurement calculation of the object of interest.

The user may be provided with a visual indication on the screen that either an accurate temperature measurement calculation can be made by displaying text such as “optimum accuracy” or that one cannot be made by displaying text such as “alarm—not accurate.” In addition, or in lieu thereof, an audio and/or vibrational/tactile indication may be rendered.

Alternatively, the graphical icon need not be a box but rather could be a mark such as an X in the center of the screen. When the user registers that mark on an object of interest, graphical or audio messaging may be provided to indicate whether the temperature measurement will be accurate or not.

Also, particularly with audio indication, the user may be told that at that distance an accurate temperature measurement calculation cannot be made and that he or she needs to move closer to the object of interest, either physically or optically, and for each new distance the user establishes, a new audio will be generated, either telling the user to still move closer or telling the user that he is close enough to the object of interest for an accurate temperature measurement calculation to be made.

FIGS. 12 and 13 are illustrations of a 3×3 pixel matrix in a state where an accurate temperature measurement calculation can and cannot be made, respectively. In FIG. 12, each pixel is shaded the same intensity indicating that each is registering a similar value and thus each pixel is reading the energy from the object of interest. In FIG. 13, each pixel is shaded differently from its neighboring pixels indicating that each pixel is reading the energy of different objects and thus the value coming out of the pixel array would not reflect an accurate temperature measurement calculation of one object of interest.

FIGS. 14 and 15 are illustrations of the 3×3 pixel matrix in a state where an accurate temperature measurement calculation can be made. Unlike FIG. 13 is which all of the pixels were registering the same value, in FIGS. 14 and 15 one or two pixels, respectively are not. The processor 118 receives the information from the pixel matrix and performs a statistical analysis on that data to see if it can be used to indicate an accurate temperature measurement calculation. The processor 118 may compute an arithmetic difference between the maximum value and minimum value associated with the data. If the difference between these maximum and minimum value associated with the data. If the difference between these maximum and minimum values exceeds a predetermined threshold, then the processor 118 discards this data as not usable as an accurate temperature measurement. In an alternate embodiment, the processor 118 computes an arithmetic average of the data. If the difference between any are of the data from each pixel and the average of the data from each pixel exceeds a predetermined threshold, then the processor 118 discards the data as unusable.

The methods discussed in the subject application may be implemented as a computer program product having a computer usable medium having a computer readable program code embodied therein, the computer readable program code adapted to be executed by the processor 118 to implement the method.

FIG. 16 is a flow chart of a method of determining whether an object of interest can have its temperature measurement calculated by a thermal imaging camera according to an embodiment of the invention. The method involves
a) measuring a distance between the camera and an object of interest (step 200);
b) calculating a measurement IFOV using the measured distance (step 202);
c) displaying the measurement IFOV on a screen of the camera as a graphical indicator (step 204);
d) registering the graphical indicator with the infrared image of the object of interest on the screen (step 206);
e) determining whether a temperature measurement of the object of interest can be acceptably calculated (step 208).

FIG. 17 is a flow chart of a method of determining whether an object of interest can have its temperature measurement calculated by a thermal imaging camera according to an embodiment of the invention. The method involves the steps of:
a) measuring a distance between the camera and the object of interest;
b) calculating a measurement IFOV using the measured distance;
c) comparing the measurement IFOV with the object of interest's size at that distance to determine whether the measurement resolution of the camera is acceptable for the object of interest's size at that distance;
d) generate a notification if the measurement resolution is not acceptable; and
e) generate a notification if the measurement resolution is acceptable (step 308).

Because the imaging camera is able to measure distance to the target, it can be used to trigger any alert or alarm that a user is positioned an unsafe distance from electrical equipment. The alert may be visual, audible and/or vibrational/tactile.

For example, a user can select a mode that the imager is being used to measure electrical equipment that requires a safe distance between the user of the imager and the equipment. Alternatively, the imager may be continuously set to a mode that indicates to a user whether they are too close to the target.

As the user uses the imager to thermally image electrical equipment, the embodiments indicate to the user whether an accurate temperature measurement can be obtained. If not, the user is directed to move closer, either optically with a lens or physically, to the target. If the user moves physically closer to the object, an indicator will indicate if the user has crossed a threshold where the user is now at an unsafe distance from the equipment. The indicator may be a visual and/or audible alarm.

In the foregoing detailed description, the invention has been described with reference to specific embodiments. However, it may be appreciated that various modifications and changes can be made without departing from the scope of the invention as set forth in the appended claims.

Imagers are frequently used for inspection of high voltage electrical equipment which has a minimum required safe distance depending on the equipment's rating.

What is claimed is:

1. A method of determining whether an object of interest can have its temperature measurement calculated by a thermal imaging camera comprising:
a) measuring a distance between the camera and an object of interest;
b) calculating a measurement IFOV using the measured distance;
c) displaying the measurement IFOV on a screen of the camera as a graphical indicator;
d) registering the graphical indicator with the infrared image of the object of interest on the screen;
e) determining whether a temperature measurement of the object of interest can be acceptably calculated.

2. The method of claim 1 further compromising indicating to a user of the camera whether a temperature measurement calculation of the object of interest will be acceptable.

3. The method of claim 1 wherein the step of displaying the measurement IFOV on the screen as a graphical indicator comprises displaying a box on the screen.

4. The method of claim 2 wherein the step of determining whether a temperature measurement calculation of the object of interest will be acceptable comprises registering the box displayed on the screen with an infrared image of the object of interest to see if the image fills a majority of the box on the display.

5. The method of claim 1 wherein the step of indicating whether a temperature measurement calculation will be acceptable comprises displaying an appropriate message on the screen.

6. The method of claim 1 wherein the step of indicating whether a temperature measurement calculation will be acceptable comprises sounding an alarm if the temperature measurement calculation will not be acceptable.

7. The method of claim 1 wherein the step of indicating whether a temperature measurement calculation will be acceptable comprises an audio recording telling the user of the camera to move closer to the object of interest in order to get an acceptable temperature measurement calculation and once the user has moved to a new distance from the object of interest, performing steps (a) through (e) and generating a new audio recording telling the user whether an acceptable temperature measurement calculation may be made at the new distance from the object or whether the user has to still move closer to the object of interest.

8. The method of claim 1 wherein step (a) is performed by a laser distance measurement device.

9. The method of claim 1 further comprising a step of calculating a spatial IFOV using the measured distance and using the calculated spatial IFOV to perform step (b) by multiplying the calculated spatial IFOV by a factor of at least 2.

10. The method of claim 1 further comprising f) determining whether the camera is an unsafe distance from the object of interest and, if so, g) generating an indicator that the camera is at an unsafe distance.

11. The method of claim 10 wherein the indicator is an alarm.

12. A method of determining whether an object of interest can have its temperature measurement calculated by a thermal imaging camera comprising:
a) measuring a distance between the camera and the object of interest;
b) calculating a measurement IFOV using the measured distance;
c) comparing the measurement IFOV with the object of interest's size at that distance to determine whether the measurement resolution of the camera is acceptable for the object of interest's size at that distance; and
d) generate a notification if the measurement resolution is not acceptable.

13. The method of claim 12 wherein step (d) comprises displaying an appropriate message on a screen of the camera.

14. The method of claim 12 wherein step (d) comprises sounding an alarm.

15. The method of claim 12 wherein step (d) comprises an audio recording telling the user of the camera to move closer to the object of interest in order to get an acceptable temperature measurement calculation and once the user has moved to a new distance from the object of interest, performing steps (a) through (e) and generating a new audio recording telling the user whether an acceptable temperature measurement calculation may be made at the new distance from the object or whether the user has to still move closer to the object of interest.

16. The method of claim 12 wherein step (a) is performed by a laser distance measurement device.

17. The method of claim 12 further comprising a step of calculating a spatial IFOV using the measured distance and using the calculated spatial IFOV to perform step (b) by multiplying the calculated spatial IFOV by a factor of at least 2.

18. The method of claim 12 further comprising e) determining whether the camera is an unsafe distance from the object of interest and, if so, f) generating an indicator that the camera is at an unsafe distance.

19. The method of claim 18 wherein the indicator is an alarm.

20. A computer program product, comprising a computer usable medium having a computer readable program code embodied therein, said computer readable program code adapted to be executed to implement a method for determining whether an object of interest can have its temperature measurement calculated by a thermal imaging camera, said method comprising:
a) measuring a distance between the camera and an object of interest;
b) calculating a measurement IFOV using the measured distance;
c) displaying the measurement IFOV on a screen of the camera as a graphical indicator;
d) registering the graphical indicator with the infrared image of the object of interest on the screen;
e) determining whether a temperature measurement calculation of the object of interest can be acceptably measured.
